(19) United States
(12) Patent Application Publication
(10) Pub. No.: US 2006/0146862 A1
(43) Pub. Date: Jul. 6, 2006

(54) Method for setting and releasing packet data protocol context of mobile communication terminal

(75) Inventor: Sung-Kyu Lee, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/319,666

(22) Filed: Dec. 29, 2005

(30) Foreign Application Priority Data
Dec. 30, 2004 (KR) 10-2004-0117375

(51) Int. Cl. H04L 12/413

(52) U.S. Cl. 370/448

(57) ABSTRACT

A packet data protocol (pdp) context requesting method for a mobile communication terminal, which includes setting a predetermined waiting response time period for transmitting a request message to request the pdp context based on a number of times a request message has been previously transmitted, and transmitting the request message based on the predetermined waiting response time period.

This application claims priority to Korean Application No. 10-2004-117375 filed in Korea on Dec. 30, 2004, the entire contents of which is incorporated by reference in its entirety.

### BACKGROUND OF THE INVENTION

1. Field of the Invention

The present invention relates to a mobile communication terminal, and more particularly, to a method for effectively establishing and releasing a packet data protocol (PDP) context of a mobile terminal by variably setting a response time period for requesting the PDP content be established or released.

2. Description of the Related Art

In general, a mobile communication system includes a Mobile Switching Center (MSC) managing a plurality of Base Stations (BS) arranged in cells to thereby allow a mobile terminal user to wirelessly contact another party any time and anywhere. Further, mobile terminals also include multimedia capabilities such as being able to send and receive pictures and data including symbols, numbers and characters.

Currently, a General Packet Radio Service (GPRS) network is provided so the wireless communication network can also access a data network. That is, the GPRS network allows the user to send and/or receive non-sound information (e.g., video) by interconnecting the GPRS network and the Internet network. Thus, the user is able to use Internet services on their mobile terminal such as an FTP (File Transfer Protocol) service, a Web browsing service, a Telnet service (used in fixed line Internet network communications), etc.

In more detail, FIG. 1 illustrates a conceptual structure of the general GPRS network. As shown in FIG. 1, the general GPRS network includes a Serving GPRS Support Node (SGSN) 30 for transmitting data packets to a mobile communication terminal 10 located within a service area through a Base Station Controller (BSC) 20, and a Gateway GPRS Support Node (GGSN) 40 for handling a logical interface between the SGSN 30 and the Internet 50 and for managing routing information.

Thus, to set a PDP context (e.g., to request an Internet service), the mobile terminal 10 transmits a message requesting activation of the appropriate PDP context to the SGSN 30 and then checks whether a message for authenticating the requested PDP context is received within a predetermined response time (which is typically 30 seconds) from the SGSN 30. If the predetermined response time lapses without receiving the authentication message, the mobile terminal 10 re-transmits the request message for requesting activation of the PDP context.

In this example, the mobile terminal 10 can re-transmit the request message requesting activation of the PDP context up to a maximum of five times. Further, when the mobile terminal 10 receives the authentication message within the predetermined response time, the PDP context is set or established in the SGSN 30. Meanwhile, to release the set PDP context, the mobile terminal 10 transmits a request message requesting de-activation of the set PDP context to the SGSN 30 and then checks to determine if a message for authenticating the de-activation PDP context has been received from the SGSN 30 within a predetermined response time, which is also typically 30 seconds.

However, the related art method for setting and releasing the PDP context is disadvantageous because when the authentication message is not received within the predetermined response time, the PDP context request message must be re-transmitted according the predetermined transmission times, which may require a maximum total duration of 2 minutes and 30 seconds (i.e., 30 seconds for each of the five total re-requests) when the PDP context is not set or released.

### SUMMARY OF THE INVENTION

Accordingly, one object of the present invention is to address the above-noted and other problems.

Another object of the present invention is to provide a method for effectively setting or releasing a PDP context in a mobile terminal by variably setting or adjusting the waiting response time period based on the number of re-transmissions of the message for requesting the PDP context.

To achieve these and other advantages and in accordance with the purpose of the present invention, as embodied and broadly described herein, the present invention provides in accordance with one aspect, a packet data protocol (PDP) context requesting method for a mobile communication terminal, which includes setting a predetermined waiting response time period for transmitting a request message to request the PDP context based on a number of times a request message has been previously transmitted), and transmitting the request message based on the predetermined waiting response time period.

According to another aspect, the present invention provides a mobile communication terminal, which includes a controller configured to set a predetermined waiting response time period for transmitting a request message to request a packet data protocol (pdp) context based on a number of times a request message has been previously transmitted, and an antenna configured to transmit the request message based on the predetermined waiting response time period.

According to yet another aspect, the present invention provides a method for handling a packet data protocol (PDP) context of a mobile communication terminal, which includes flexibly assigning an appropriate authentication wait duration associated with each occasion of transmission of a request to activate or de-activate a PDP context, performing one or more transmissions of the request to activate or de-activate the PDP context, and checking whether an authentication of the request is received within the authentication wait duration respectively assigned to that transmission occasion, and setting or releasing the PDP context when authentication of the request to activate or de-activate the PDP context is received.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The invention will be described in detail with reference to the following drawings in which like reference numerals refer to like elements, wherein:

FIG. 1 shows a conceptual diagram of a general GPRS network;

FIG. 2 is a flow chart illustrating a method for setting a PDP context of a mobile communication terminal in accordance with an embodiment of the present invention;

FIG. 3 is a flow chart illustrating a method for releasing a PDP context of a mobile communication terminal in accordance with an embodiment of the present invention; and

FIG. 4 is a block diagram of a mobile communication terminal in accordance with an embodiment of the present invention.

### DETAILED DESCRIPTION OF THE PREFERRED EMBODIMENTS

The method for effectively setting and releasing a PDP context of a mobile communication terminal in accordance with embodiments of the present invention will now be described with reference to the accompanying drawings.

The present inventor advantageously determined that a non-flexible or fixed time period for waiting to receive authentication for activating or de-activating a PDP context is unnecessary and disadvantageous in many situations. Thus, the present inventor advantageously developed a technique that flexibly assigns an appropriate time period for one or more transmissions of the PDP context, whereby each n-th transmission may have an independent duration (i.e., time period for waiting) based upon the conditions of the communication environment and/or due to other factors.

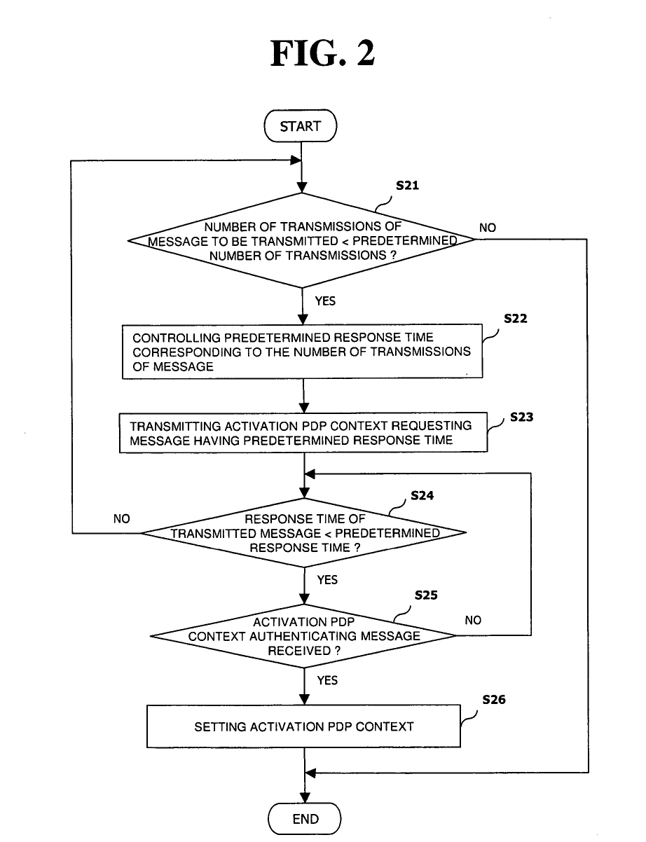

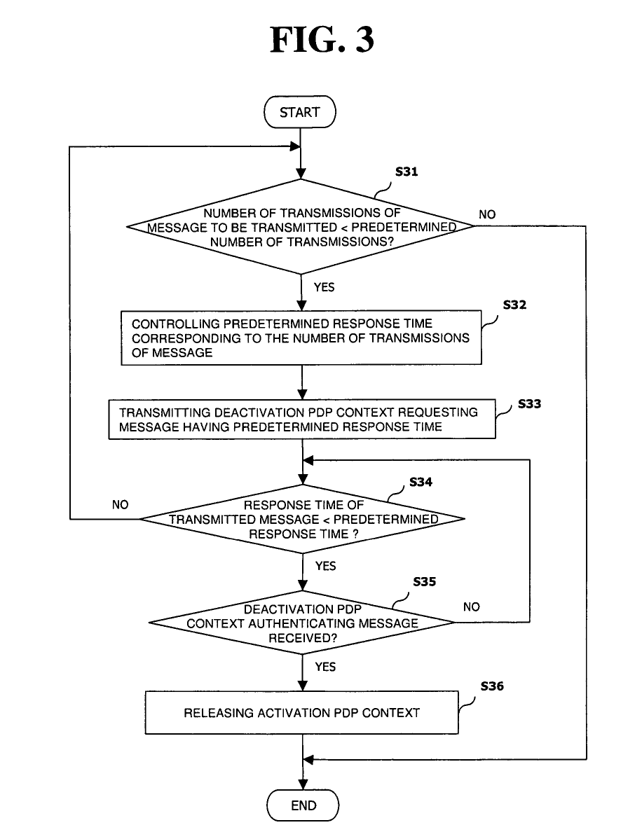

In more detail, FIG. 2 is a flow chart illustrating the method of setting a PDP context of a mobile terminal in accordance with an embodiment of the present invention. FIG. 3, which is discussed later, illustrates a method of releasing a PDP context in accordance with another embodiment of the present invention.

As shown in FIG. 2, the PDP context setting method includes checking whether a number of transmitted messages for re-requesting an activation of a PDP context is smaller than a predetermined number of transmissions (step S21). The method also includes controlling a predetermined waiting response time period before another re-request message is retransmitted based on the number of previously transmitted re-request messages (step S22), transmitting a re-request message requesting activation of the PDP context in accordance with the controlled predetermined waiting response time period (step S23), determining whether a response time from when the previous message was transmitted is within the controlled predetermined waiting response time period (step S24), checking whether an authentication message for authenticating the requested PDP context has been received (step S25), and setting the activation PDP context when the message for authenticating the activation PDP context has been received.

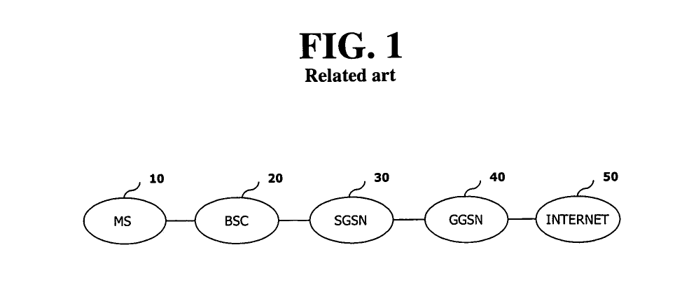

Thus, with reference to FIGS. 1 and 2, the mobile terminal 10 first checks whether a number of transmitted re-request messages for the activation of a particular PDP context is within an allowed predetermined number of transmissions (step S21). For example, the allowed predetermined number of re-transmissions may be set at five transmissions, meaning the total number of requests is limited to six (i.e., the original request and five re-requests). When the number of transmitted re-request messages is within the allowed predetermined number of times (Yes in step S21), the mobile terminal 10 controls the amount of time period that must be waited before another re-request message can be transmitted based on how many previous re-request messages have been transmitted (step S22).

For example, when the mobile terminal 10 determines the maximum number of transmissions for re-requesting the activation of the PDP context is set at five times, the mobile terminal 10 can set the amount of time that must be waited for a re-request message (waiting response time period) as 30 seconds for a first re-request message, as 20 seconds for a second re-request message, as 10 seconds for a third re-request message, as 5 seconds for a fourth re-request message, and as 5 seconds for a fifth and final re-request message.

Then, as shown in FIG. 2, the terminal 10 transmits the activation PDP context re-request message to the SGSN 30 via the BSC 20 and then starts counting a response time (hereinafter referred to as a “counted response time period”) it takes to receive an authentication response for authenticating the requested PDP context (step S23). The mobile terminal 10 may count the response time via a counter, which is initialized and driven to count when the re-request message is transmitted. Thus, the mobile terminal 10 can determine whether or not an authentication message is received within the predetermined waiting response time period controlled or set by the terminal 10 in step S22 (e.g., 30, 20, 10, 5 or 5 seconds depending on the particular re-request message).

That is, the communication terminal 10 determines whether or not the counted response time period is within the controlled predetermined waiting response time period (step S24). When the counted response time is within the controlled predetermined waiting response time period (Yes in step S24), the mobile communication terminal 10 checks whether the authentication message for the requested activation of the PDP context has been received (step S25). If the counted response time period is not less than the controlled or set predetermined waiting response time period (No in step S24), the mobile terminal 10 re-transmits the activation PDP context requesting message.

Returning to step S25, if the mobile terminal 10 has received the activation PDP context authentication message (Yes in step S25), the terminal 10 sets the requested PDP context with the SGSN 30 (step S26). Then, the GPRS network and the Internet 50 are interconnected through the set PDP context such that the mobile terminal 10 can perform data communication in the wireless communication network. On the contrary, if the mobile terminal 10 does not receive the activation PDP context authentication message (No in step S25), the terminal 10 again determines whether the counted response time period is within the predetermined controlled waiting response time period (step S24).

Further, the above-description of FIG. 2 corresponds to re-request messages. However, the method shown in FIG. 2 may also apply to the very first request message transmitted. That is, when transmitting the first request message, the method determines if the number of transmissions is less than the predetermined number of allowed total transmissions. In this example, because no other messages have been sent (i.e., it's the first request message sent), the predetermined waiting response time period would be set at 30 seconds before the next request message (i.e., the first re-request message) is sent. The other steps in FIG. 2 also would apply. Similar comments apply to FIG. 3, which will be described next.

In more detail, FIG. 3 illustrates the method of de-activating or releasing a set PDP context. The process is substantially the reverse of the process of requesting and setting the PDP context discussed above with respect to FIG. 2.

As shown in FIG. 3, the PDP context releasing method includes checking whether a number of transmitted messages for re-requesting release of a PDP context is smaller than a predetermined number of transmissions (step S31). The releasing method also includes controlling a predetermined waiting response time period before another re-request message is transmitted based on the number of previously transmitted re-request messages (step S32), transmitting a re-request message requesting release of the PDP context in accordance with the controlled predetermined waiting response time period (step S33), determining whether a response time from when the previous message was transmitted is within the controlled predetermined waiting response time period (step 324), checking whether an authentication message for authenticating the requested release of the PDP context has been received (step S35), and releasing the activation PDP context when the message for authenticating the release of the PDP context has been received.

Thus, with reference to FIGS. 1 and 3, the mobile terminal 10 first checks whether a number of transmitted re-request messages for the release of a particular PDP context is within an allowed predetermined number of transmissions (step S31). For example, as discussed above, the allowed predetermined number of re-transmissions may be set at five transmissions, meaning the total number of requests is limited to six. The total number of allowed release requests may also be set to be different than the total number of activation requests. Further, when the number of transmitted re-request messages is within the allowed predetermined number of times (Yes in step S31), the mobile terminal 10 controls or sets the amount of time period that must be waited before another re-request message requesting release of the PDP context can be transmitted based on how many previous re-request messages have been transmitted (step S32).

For example, when the mobile terminal 10 determines the maximum number of transmissions for re-requesting the release of the PDP context is set at five times, the mobile terminal 10 can set the amount of time that must be waited for a re-request message of (waiting response time period) as 8 seconds for a first re-request message, as 5 seconds for a second re-request message, as 5 seconds for a third re-request message, as 3 seconds for a fourth re-request message and as 3 seconds for a fifth and final re-request message.

Then, as shown in FIG. 3, the terminal 10 transmits the release PDP context re-request message to the SGSN 30 via the BSC 20 and then starts counting a response time (the counted response time period) it takes to receive an authentication response for releasing the requested PDP context (step S33). The mobile terminal 10 may count the response time via a counter as discussed above. Thus, the mobile terminal 10 can determine whether or not an authentication message is received within the predetermined waiting response time period controlled or set by the terminal 10 in step S32 (e.g., 8, 5, 5, 3 or 3 seconds depending on the particular re-request message).

That is, the communication terminal 10 determines whether or not the counted response time period is within the controlled predetermined waiting response time period (step S34). When the counted response time is within the controlled predetermined waiting response time period (Yes in step S34), the mobile communication terminal 10 checks whether the authentication message for the requested release of the PDP context has been received (step S35). If the counted response time period is not less than the controlled or set predetermined waiting response time period (No in step S34), the mobile terminal 10 re-transmits the release PDP context requesting message.

Returning to step S35, if the mobile terminal 10 has received the release PDP context authentication message (Yes in step S35), the terminal 10 releases the requested PDP context with the SGSN 30 (step S36). On the contrary, if the mobile terminal 10 does not receive the release PDP context authentication message (No in step S35), the terminal 10 again determines whether the counted response time period is within the predetermined controlled waiting response time period (step S34).

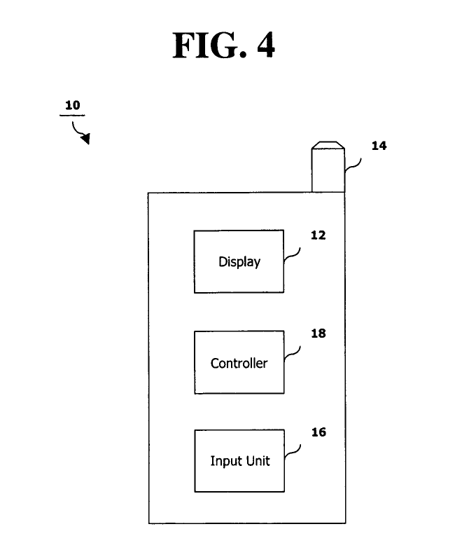

Turning next to FIG. 4 which is a block diagram illustrating the mobile communication terminal 10 in accordance with an embodiment of the present invention. As shown, the terminal 10 includes a display 12, antenna 14, input unit 16 and controller 18. The controller 18 controls operations of the terminal 10 and performs the method of the present invention as discussed above.

Thus, in accordance with the present invention, the terminal 10 can set or control a predetermined waiting response time period for requesting the activation and release of a PDP context based on a maximum number of previous transmissions. Thus, the mobile terminal 10 can variably control how the predetermined waiting response time based on the number of previous requests is set.

In addition, the particular durations for the response waiting time periods of each subsequent re-transmission may be varied depending upon the communication environment or other factors. For example, if the weather conditions poorly effect transmission/reception capabilities of the mobile terminal 10, the predetermined waiting times may be set to be longer than if the weather conditions did not poorly effect transmission/reception capabilities of the mobile terminal 10. In addition, the predetermined wait times may be set by the user or preset by a manufacturing company of the mobile terminal or a service provider for the mobile terminal.

Also, one or more appropriate authentication wait durations may be pre-set before a first transmission is performed. Additionally, the appropriate authentication wait duration period may be determined whenever each transmission occasion is to be performed. Furthermore, the authentication wait duration for an initial transmission may be longer than that for a subsequent transmission. Other variations are also possible. In addition, the mobile terminal may be, for example, a handset terminal, a mobile phone, or other wireless communication device.

Thus, as discussed above, the present invention provides a method for handling a PDP context of a mobile communication terminal by flexibly assigning an appropriate authentication wait duration period associated with each occasion of transmission of a request to activate or de-activate a PDP context.

As so far described, the method for setting and releasing the PDP context of the mobile terminal is advantageous, because the PDP context can be effectively set or released by controlling the predetermined waiting response time period with respect to the PDP context requesting message according to the number of re-transmissions (or transmissions) of the PDP context requesting message and/or other communication factors.

This invention may be conveniently implemented using a conventional general purpose digital computer or microprocessor programmed according to the teachings of the present specification, as will be apparent to those skilled in the computer art. Appropriate software coding can readily be prepared by skilled programmers based on the teachings of the present disclosure, as will be apparent to those skilled in the software art. The invention may also be implemented by the preparation of application specific integrated circuits whereby interconnecting an appropriate network of conventional computer circuits, as will be readily apparent to those skilled in the art.

Any portion of the present invention implemented on a general purpose digital computer or microprocessor includes a computer program product which is a storage medium including instructions which can be used to program a computer to perform a process of the invention. The storage medium can include, but is not limited to, any type of disk including floppy disk, optical disk, CD-ROMs, and magneto-optical disks, ROMs, RAMs, EPROMs, EEPROMs, magnetic or optical cards, or any type of media suitable for storing electronic instructions.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A packet data protocol (pdp) context requesting method for a mobile communication terminal, the method comprising:
setting a predetermined waiting response time period for transmitting a request message to request the pdp context based on a number of times a request message has been previously transmitted; and
transmitting the request message based on the predetermined waiting response time period.

2. The method of claim 1, wherein the request message requests activation of the pdp context.

3. The method of claim 1, wherein the request message requests de-activation of an activated pdp context.

4. The method of claim 1, further comprising:
checking whether an authentication message indicating the requested pdp context has been authenticated is received when a current time from when the request message was transmitted in the transmitting step is less than the predetermined waiting response time period.

5. The method of claim 4, further comprising:
establishing the requested pdp context when the authentication message is received.

6. The method of claim 1, wherein the setting step comprises:
checking whether the number of times the request message has been previously transmitted is smaller than a maximum number of allowable transmissions; and
setting the predetermined waiting response time period for the request message according to the checked number of times the request message has been previously transmitted.

7. The method of claim 6, wherein the maximum number of allowable transmissions is five.

8. The method of claim 6, wherein the predetermined waiting response time period is reduced by a predetermined value as the number of times the request message has been previously transmitted increases.

9. The method of claim 4, wherein the transmitting step comprises:
counting a period of time starting from when the request message was transmitted.

10. The method of claim 9, wherein the counted period of time refers to a time period from when the request message was transmitted to when the authentication message is received.

11. The method of claim 4, wherein the checking step comprises:
determining whether the current time from when the request message was transmitted is less than the predetermined waiting response time period, and then checking whether the authentication message has been received when the current time from when the request message was transmitted is less than the predetermined waiting response time period.

12. The method of claim 11, wherein when the current time from when the request message was transmitted is greater than the predetermined waiting response time period, the setting step sets the predetermined waiting response time period for transmitting the request message to request the pdp context based on the number of times the request message has been previously transmitted.

13. The method of claim 12, wherein when the checking step determines the authentication message has not been received within the predetermined waiting response time period, the determining step determines whether the current time period from when the request message was transmitted is less than the predetermined waiting response time period.

14. The method of claim 1, wherein the mobile communication terminal is one of a mobile phone, a pda (personal digital assistant), or a notebook computer.

15. A mobile communication terminal, comprising:
a controller configured to set a predetermined waiting response time period for transmitting a request message to request a packet data protocol (pdp) context based on a number of times a request message has been previously transmitted; and
an antenna configured to transmit the request message based on the predetermined waiting response time period.

16. The terminal of claim 15, wherein the request message requests activation of the pdp context.

17. The terminal of claim 15, wherein the request message requests de-activation of an activated pdp context.

18. The terminal of claim 15, wherein the controller checks whether an authentication message indicating the requested pdp context has been authenticated is received when a current time from when the request message was transmitted is less than the predetermined waiting response time period.

19. The terminal of claim 18, wherein the controller establishes the requested pdp context when the authentication message is received.

20. The terminal of claim 15, wherein the controller further checks whether the number of times the request message has been previously transmitted is smaller than a maximum number of allowable transmissions, and sets the predetermined waiting response time period for the request message according to the checked number of times the request message has been previously transmitted.

21. The terminal of claim 20, wherein the maximum number of allowable transmissions is five.

22. The terminal of claim 20, wherein the predetermined waiting response time period is reduced by a predetermined value as the number of times the request message has been previously transmitted increases.

23. The terminal of claim 18, wherein the controller further counts a period of time starting from when the request message was transmitted.

24. The terminal of claim 23, wherein the counted period of time refers to a time period from when the request message was transmitted to when the authentication message is received.

25. The terminal of claim 18, wherein the controller determines whether the current time from when the request message was transmitted is less than the predetermined waiting response time period, and then checks whether the authentication message has been received when the current time from when the request message was transmitted is less than the predetermined waiting response time period.

26. The terminal of claim 25, wherein when the current time from when the request message was transmitted is greater than the predetermined waiting response time period, the controller sets the predetermined waiting response time period for transmitting the request message to request the PDP context based on the number of times the request message has been previously transmitted.

27. The terminal of claim 26, wherein when the checking step determines the authentication message has not been received within the predetermined waiting response time period, the controller determines whether the current time period from when the request message was transmitted is less than the predetermined waiting response time period.

28. The terminal of claim 15, wherein the mobile communication terminal is one of a mobile phone, a pda (personal digital assistant), or a notebook computer.

29. A method for handling a packet data protocol (pdp) context of a mobile communication terminal, the method comprising:
flexibly assigning an appropriate authentication wait duration associated with each occasion of transmission of a request to activate or de-activate a pdp context;
performing one or more transmissions of the request to activate or de-activate the pdp context, and checking whether an authentication of the request is received within the authentication wait duration respectively assigned to that transmission occasion; and
setting or releasing the pdp context when authentication of the request to activate or de-activate the pdp context is received.

30. The method of claim 29, wherein the appropriate authentication wait durations are assigned according to conditions of a communication environment.

31. The method of claim 29, wherein at least one appropriate authentication wait duration is pre-set before a first transmission is performed.

32. The method claim 29, wherein the appropriate authentication wait duration is determined whenever each transmission occasion is to be performed.

33. The method claim 29, wherein the authentication wait duration for an initial transmission is longer than that for a subsequent transmission.
